(19) United States
(12) Patent Application Publication
(10) Pub. No.: US 2023/0407091 A1
(43) Pub. Date: Dec. 21, 2023

(54) Laser Activatable Polymer Composition

(71) Applicant: Ticona LLC, Florence, KY (US)

(72) Inventors: Zhe Tan, Shanghai (CN); Michael Schaefer, Maintal (DE); Yuehua YU, Cincinnati, OH (US); Fangfang Tao, Shanghai (CN); Christopher McGrady, Walton, KY (US); Xinyu Zhao, Cincinnati, OH (US)

(21) Appl. No.: 18/335,177

(22) Filed: Jun. 15, 2023

Related U.S. Application Data
(60) Provisional application No. 63/353,965, filed on Jun. 21, 2022.

(51) Int. Cl. C08L 81/04; H01Q 1/22; H01Q 21/06

(52) U.S. Cl. CPC C08L 81/04; H01Q 1/22; H01Q 21/065

(57) ABSTRACT

A laser activatable polymer composition is provided. The composition contains a polymer matrix that includes at least one polyarylene sulfide and at least one condensation polymer; at least one laser activatable additive; and inorganic fibers. The polymer composition exhibits a dielectric constant of about 5 or less at a frequency of 2 GHz, a flexural modulus of about 13,500 MPa or more as determined at a temperature of 23° C. in accordance with ISO 178:2019, and a deflection temperature under load of about 260° C. or more as determined in accordance with ISO 75:2013 at a load of 1.8 MPa.

### RELATED APPLICATION

The present application is based upon and claims priority to U.S. Provisional Patent Application Ser. No. 63/353,965, having a filing date of Jun. 21, 2022, which is incorporated herein by reference.

### BACKGROUND OF THE INVENTION

To form the antenna structure of various electronic components, molded interconnect devices (“MID”) often contain a plastic substrate on which is formed conductive elements or pathways. Such MID devices are thus three-dimensional molded parts having an integrated printed conductor or circuit layout. It is becoming increasingly popular to form MIDs using a laser direct structuring (“LDS”) process during which a computer-controlled laser beam travels over the plastic substrate to activate its surface at locations where the conductive path is to be situated. With a laser direct structuring process, it is possible to obtain conductive element widths and spacings of 150 microns or less. As a result, MIDs formed from this process save space and weight in the end-use applications. Various polymer formulations, such as laser activatable polycarbonate resins, have been developed for use in MIDs, but these polymer formulations do not typically have a high degree of inherent flame resistance, which can limit their use in certain 5G applications. While various attempts have been made to employ polymers with inherent flame resistance (e.g., polyphenylene sulfide), formulations made from these materials are difficult to activate with a laser and also tend to exhibit a high degree of warpage, which is problematic, particularly when employed in thin substrates that are commonly required for 5G applications.

As such, a need exists for a laser activatable polymer composition that can possesses sufficient properties for use in a wide variety of 5G applications.

### SUMMARY OF THE INVENTION

In accordance with one embodiment of the present invention, a polymer composition is disclosed that comprises 100 parts by weight of a polymer matrix that includes at least one polyarylene sulfide in an amount of from about 10 wt. % to about 60 wt. % of the polymer composition and at least one condensation polymer in an amount of from about 5 wt. % to about 35 wt. % of the polymer composition; from about 1 to about 30 parts by weight of at least one laser activatable additive; and from about 40 to about 100 parts by weight of inorganic fibers. The polymer composition exhibits a dielectric constant of about 5 or less at a frequency of 2 GHz, a flexural modulus of about 14,000 MPa or more as determined at a temperature of 23° C. in accordance with ISO 178:2019, and a deflection temperature under load of about 260° C. or more as determined in accordance with ISO 75:2013 at a load of 1.8 MPa.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIGS. 1-2 are respective front and rear perspective views of one embodiment of an electronic component that can employ an antenna system;

FIG. 3 is a top view of an illustrative inverted-F antenna resonating element for one embodiment of an antenna system;

FIG. 4 is a top view of an illustrative monopole antenna resonating element for one embodiment of an antenna system;

FIG. 5 is a top view of an illustrative slot antenna resonating element for one embodiment of an antenna system;

FIG. 6 is a top view of an illustrative patch antenna resonating element for one embodiment of an antenna system;

FIG. 7 is a top view of an illustrative multibranch inverted-F antenna resonating element for one embodiment of an antenna system;

FIG. 8 depicts a 5G antenna system including a base station, one or more relay stations, one or more user computing devices, one or more or more Wi-Fi repeaters according to aspects of the present disclosure;

FIG. 9A illustrates a top-down view of an example user computing device including 5G antennas according to aspects of the present disclosure;

FIG. 9B illustrates a side elevation view of the example user computing device of FIG. 9A including 5G antennas according to aspects of the present disclosure;

FIG. 10 illustrates an enlarged view of a portion of the user computing device of FIG. 9A;

FIG. 11 illustrates a side elevation view of co-planar waveguide antenna array configuration according to aspects of the present disclosure;

FIG. 12A illustrates an antenna array for massive multiple-in-multiple-out configurations according to aspects of the present disclosure;

FIG. 12B illustrates an antenna array formed with laser direct structuring according to aspects of the present disclosure;

FIG. 12C illustrates an example antenna configuration according to aspects of the present disclosure; and

FIGS. 13A through 13C depict simplified sequential diagrams of a laser direct structuring manufacturing process that can be used to form an antenna system.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a laser activatable polymer composition that contains a polymer matrix that includes at least one polyarylene sulfide and at least one condensation polymer, at least one laser activatable additive, and inorganic fibers. Through careful selection of the particular nature and concentration of the components of the polymer composition, the present inventors have discovered that the resulting composition can exhibit a low dielectric constant over a wide range of frequencies, making it particularly suitable for use in 5G applications. That is, the polymer composition may exhibit a low dielectric constant of about 5 or less, in some embodiments about 4.5 or less, in some embodiments from about 0.1 to about 4.4, in some embodiments from about 1 to about 4.3, and in some embodiments, from about 2 to about 4.2, as determined by the split post resonator method over typical 5G frequencies (e.g., 2 GHz or 10 GHz). The dissipation factor of the polymer composition, which is a measure of the loss rate of energy, may likewise be about 0.05 or less, in some embodiments about 0.01 or less, in some embodiments from about 0.0001 to about 0.008, and in some embodiments from about 0.0002 to about 0.006 over typical 5G frequencies (e.g., 2 or 10 GHz).

Conventionally, it was believed that laser activatable polymer compositions exhibiting a low dielectric constant and/or dissipation factor would not possess sufficiently good thermal, mechanical properties and ease in processing (i.e., low viscosity) to enable their use in 5G applications. Contrary to conventional thought, however, the polymer composition has been found to possess both excellent thermal, mechanical properties and processability. The melting temperature of the composition may, for instance, be from about 250° C. to about 440° C., in some embodiments from about 260° C. to about 400° C., and in some embodiments, from about 280° C. to about 380° C. Even at such melting temperatures, the ratio of the deflection temperature under load (“DTUL”), a measure of short term heat resistance, to the melting temperature may still remain relatively high. For example, the ratio may range from about 0.5 to about 1.00, in some embodiments from about 0.6 to about 0.95, and in some embodiments, from about 0.65 to about 0.85. The specific DTUL values may, for instance, range be about 260° C. or more, in some embodiments from about 260° C. to about 350° C., and in some embodiments, from about 265° C. to about 320° C., such as determined in accordance with ISO 75:2013 at a load of 1.8 MPa. Such high DTUL values can, among other things, allow the use of high speed and reliable surface mounting processes for mating the structure with other components of the electrical component.

The polymer composition may also exhibit a relative high flexural modulus, which is useful when forming thin substrates for 5G applications. The flexural modulus may, for instance, be about 13,500 MP or more, in some embodiments about 14,000 MPa or more, in some embodiments from about 15,000 MPa to about 30,000 MPa, and in some embodiments, from about 16,000 MPa to about 25,000 MPa, such as determined at a temperature of 23° C. in accordance with 178:2019. Other flexural properties of the polymer composition may also be good. For example, the polymer composition may exhibit a flexural strength of about 160 MPa or more, in some embodiments from about 170 to about 350 MPa, and in some embodiments, from about 180 to about 250 MPa and/or a flexural elongation of about 0.4% or more, in some embodiments from about 0.5% to about 10%, and in some embodiments, from about 0.6% to about 3.5%, such as determined in accordance with 178:2019 at a temperature of about 23° C.

The polymer composition may also exhibit good tensile properties, such as a tensile strength of about 110 MPa or more, in some embodiments from about 112 to about 350 MPa, and in some embodiments, from about 115 to about 250 MPa; a tensile break strain of about 0.4% or more, in some embodiments from about 0.5% to about 10%, and in some embodiments, from about 0.6% to about 3.5%; and/or a tensile modulus of about 13,500 MPa or more, in some embodiments about 14,000 MPa or more, in some embodiments from about 14,000 MPa to about 30,000 MPa, and in some embodiments, from about 15,000 MPa to about 25,000 MPa, such as determined in accordance with ISO 527:2019 at a temperature of about 23° C. Furthermore, the polymer composition may also possess a high impact strength, which may be useful when forming thin articles. The polymer composition may, for instance, possess a Charpy impact strength (un-notched) of about 15 kJ/m² or more, in some embodiments from about 16 kJ/m² to about 35 kJ/m², and in some embodiments from about 20 kJ/m² to about 30 kJ/m² and/or a Charpy impact strength (notched) of about 5 kJ/m² or more, in some embodiments from about 6 kJ/m² to about 25 kJ/m², and in some embodiments from about 7 kJ/m² to about 20 kJ/m², such as determined in accordance with ISO 179:2020 at a temperature of about 23° C.

The polymer composition can also exhibit good flame retardant characteristics. For instance, a polymer composition can meet the V-0 flammability standard at a variety of thicknesses, such as 0.4 mm, 0.8 mm, or 1 mm. The flame retarding efficacy may be determined according to the UL 94 Vertical Burn Test procedure of the “Test for Flammability of Plastic Materials for Parts in Devices and Appliances”, 5th Edition, Oct. 29, 1996. The ratings according to the UL 94 test are listed in the following table:

| Rating | Afterflame Time (s) | Burning Drips | Burn to Clamp |
|---|---|---|---|
| V-0 | <10 | No | No |
| V-1 | <30 | No | No |
| V-2 | <30 | Yes | No |
| Fail | <30 | | Yes |
| Fail | >30 | | No |

The “afterflame time” is an average value determined by dividing the total afterflame time (an aggregate value of all samples tested) by the number of samples. The total afterflame time is the sum of the time (in seconds) that all the samples remained ignited after two separate applications of a flame as described in the UL-94 VTM test. Shorter time periods indicate better flame resistance, i.e., the flame went out faster. For a V-0 rating, the total afterflame time for five (5) samples, each having two applications of flame, must not exceed 50 seconds. The polymer composition may achieve at least a V-1 rating, and typically a V-0 rating, for specimens having a variety of thicknesses, such as 0.4 mm, 0.8 mm, or 1 mm.

As a result of the properties noted above, the polymer composition can be readily shaped into a substrate that can be subsequently applied with one or more conductive elements using a laser direct structuring process (“LDS”). Due to the beneficial properties of the polymer composition, the resulting substrate may have a very small size, such as a thickness of about 5 millimeters or less, in some embodiments about 4 millimeters or less, and in some embodiments, from about 0.1 to about 3 millimeters. If desired, the conductive elements may be antennas (e.g., antenna resonating elements) so that the resulting part is an antenna structure that may be employed in a wide variety of different electronic components, such as cellular telephones, automotive equipment, etc.

Various embodiments of the present invention will now be described in more detail.

### I. Polymer Composition

A. Polymer Matrix

As indicated above, the polymer matrix contains at least one polyarylene sulfide. Polyarylene sulfides typically constitute from about 10 wt. % to about 60 wt. %, in some embodiments from about 20 wt. % to about 55 wt. %, and in some embodiments, from about 25 wt. % to about 50 wt. % of the polymer composition. The polyarylene sulfide(s) employed in the composition generally have repeating units of the formula:

—[(Ar¹)ₙ—X]ₘ—[(Ar²)ᵢ—Y]ᵢ—[(Ar³)ₖ—Z]ₗ—[(Ar⁴)ₒ—W]ₚ—

wherein,
Ar¹, Ar², Ar³, and Ar⁴ are independently arylene units of 6 to 18 carbon atoms;
W, X, Y, and Z are independently bivalent linking groups selected from —SO₂—, —S—, —SO—, —CO—, —O—, —C(O)O— or alkylene or alkylidene groups of 1 to 6 carbon atoms, wherein at least one of the linking groups is —S—; and
n, m, i, j, k, l, o, and p are independently 0, 1, 2, 3, or 4, subject to the proviso that their sum total is not less than 2.

The arylene units Ar¹, Ar², Ar³, and Ar⁴ may be selectively substituted or unsubstituted. Advantageous arylene units are phenylene, biphenylene, naphthalene, anthracene and phenanthrene. The polyarylene sulfide typically includes more than about 30 mol %, more than about 50 mol %, or more than about 70 mol % arylene sulfide (—S—) units. For example, the polyarylene sulfide may include at least 85 mol % sulfide linkages attached directly to two aromatic rings. In one particular embodiment, the polyarylene sulfide is a polyphenylene sulfide, defined herein as containing the phenylene sulfide structure —(C₆H₄—S)ₙ— (wherein n is an integer of 1 or more) as a component thereof.

Synthesis techniques that may be used in making a polyarylene sulfide are generally known in the art. By way of example, a process for producing a polyarylene sulfide can include reacting a material that provides a hydrosulfide ion (e.g., an alkali metal sulfide) with a dihaloaromatic compound in an organic amide solvent. The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene; 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone. The halogen atom can be fluorine, chlorine, bromine or iodine, and two halogen atoms in the same dihalo-aromatic compound may be the same or different from each other. In one embodiment, o-dichlorobenzene, m-dichlorobenzene, p-dichlorobenzene or a mixture of two or more compounds thereof is used as the dihalo-aromatic compound. As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The polyarylene sulfide(s) may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

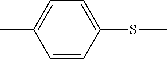

and segments having the structure of formula:

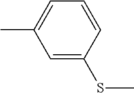

or segments having the structure of formula:

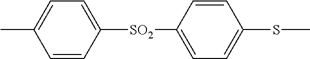

The polyarylene sulfide(s) may be linear, semi-linear, branched or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′, 4,4′-tetrachlorobiphenyl, 2,2′, 5,5′-tetra-iodobiphenyl, 2,2′, 6,6′-tetrabromo-3,3′, 5,5′-tetramethylbiphenyl, 1,2,3,4-tetrachloronaphthalene, 1,2,4-tribromo-6-methylnaphthalene, etc., and mixtures thereof.

If desired, the polyarylene sulfide can be functionalized. For instance, a disulfide compound containing reactive functional groups (e.g., carboxyl, hydroxyl, amine, etc.) can be reacted with the polyarylene sulfide. Functionalization of the polyarylene sulfide can further provide sites for bonding between other components and the polyarylene sulfide, which can improve distribution of the components throughout the polyarylene sulfide and prevent phase separation. The disulfide compound may undergo a chain scission reaction with the polyarylene sulfide during melt processing to lower its overall melt viscosity. When employed, disulfide compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula:

R³—S—S—R⁴

wherein R³ and R⁴ may be the same or different and are hydrocarbon groups that independently include from 1 to about 20 carbons. For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at terminal end(s) of the disulfide compound. For example, at least one of R³ and R⁴ may include a terminal carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid (or 2,2′-dithiobenzoic acid), dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole), 2-(4′-morpholinodithio)benzothiazole, etc., as well as mixtures thereof.

The melt flow rate of a polyarylene sulfide incorporated in a composition can be from about 100 to about 800 grams per 10 minutes (“g/10 min”), in some embodiments from about 200 to about 700 g/10 min, and in some embodiments, from about 300 to about 600 g/10 min, as determined in accordance with ISO 1133 at a load of 5 kg and temperature of 316° C.

The polymer composition also contains one or more condensation polymers which, among other things, can enhance the ability of the composition to undergo laser activation. To help achieve a composition that can be laser activated without sacrificing the desirable properties provided by the polyarylene sulfide(s), the weight ratio of polyarylene sulfides to condensation polymers in the composition typically ranges from about 1.5 to about 5, in some embodiments from about 1.8 to about 4, and in some embodiments, from about 2 to about 3. Condensation polymers may, for instance, constitute from about 5 wt. % to about 35 wt. %, in some embodiments from about 8 wt. % to about 30 wt. %, and in some embodiments, from about 10 wt. % to about 25 wt. % of the polymer content of the composition.

Any of a variety of condensation polymers may generally be employed in the polymer composition. Examples of such polymers include, for instance, aromatic, aliphatic, and/or aliphatic-aromatic polyesters, polyamides, polyacrylamides, polyimides, etc. In one embodiment, the condensation polymer is an aromatic polyester. One example of such a polymer is a liquid crystalline polymer. Liquid crystalline polymers, which are generally classified as “thermotropic” to the extent that they can possess a rod-like structure and exhibit a crystalline behavior in their molten state (e.g., thermotropic nematic state). The a liquid crystalline polymers employed in the polymer composition typically have a melting temperature of from about 200° C. to about 400° C., in some embodiments from about 250° C. to about 380° C., in some embodiments from about 270° C. to about 360° C., and in some embodiments from about 300° C. to about 350° C. The melting temperature may be determined as is well known in the art using differential scanning calorimetry (“DSC”), such as determined by ISO Test No. 11357-3:2011. Such polymers may be formed from one or more types of repeating units as is known in the art. A liquid crystalline polymer may, for example, contain one or more aromatic ester repeating units generally represented by the following Formula (I):

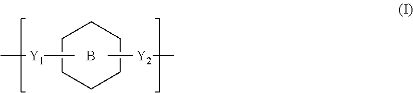

wherein,
ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and
Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic hydroxycarboxylic repeating units, for instance, may be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute from about 20 mol. % to 100 mol. %, in some embodiments from about 30 mole % to about 90 mol. %, in some embodiments from about 40 mol. % to about 80 mol. %, and in some embodiments, from about 50 mol. % to about 70 mol. % of the polymer. When employed, the molar ratio of repeating units derived from HBA to the repeating units derived from HNA may be selectively controlled within a specific range to help achieve certain desired properties, such as from about 5 to about 40, in some embodiments from about 6 to about 35, and in some embodiments, from about 10 to about 25.

Aromatic dicarboxylic repeating units may also be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) each typically constitute from about 1 mol. % to about 40 mol. %, in some embodiments from about 2 mol. % to about 30 mol. %, and in some embodiments, from about 5 mol. % to about 25% of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) each typically constitute from about 1 mol. % to about 40 mol. %, in some embodiments from about 2 mol. % to about 30 mol. %, and in some embodiments, from about 5 mol. % to about 25% of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10% of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

In certain embodiments, “low naphthenic” liquid crystalline polymers may be employed in the composition in which the total amount of repeating units derived from naphthenic hydroxycarboxylic and/or dicarboxylic acids (e.g., NDA, HNA, or a combination of HNA and NDA) is about 15 mol. % or less, in some embodiments about 12 mol. % or less, in some embodiments about 10 mol. % or less, and in some embodiments, from about 1 mol. % to about 8 mol. % of the polymer. Of course, in certain embodiments, it may also be desirable to employ a “high naphthenic” polymer to the extent that it contains a relatively high content of repeating units derived from naphthenic hydroxycarboxylic acids and naphthenic dicarboxylic acids, such as NDA, HNA, or combinations thereof. That is, the total amount of repeating units derived from naphthenic hydroxycarboxylic and/or dicarboxylic acids (e.g., NDA, HNA, or a combination of HNA and NDA) is typically about 15 mol. % or more, in some embodiments about 18 mol. % or more, in some embodiments about 30 mol. % or more, in some embodiments about 40 mol. % or more, in some embodiments about 45 mol. % or more, in some embodiments about 50 mol. % or more, in some embodiments about 60 mol. % or more, in some embodiments about 62 mol. % or more, in some embodiments about 68 mol. % or more, in some embodiments about 70 mol. % or more, and in some embodiments, from about 70 mol. % to about 80 mol. % of the polymer. In certain cases, such “high naphthenic” polymers may be capable of reducing the tendency of the polymer composition to absorb water, which can help stabilize the dielectric constant at high frequency ranges. Namely, such high naphthenic polymers typically have a water adsorption of about 0.015% or less, in some embodiments about 0.01% or less, and in some embodiments, from about 0.0001% to about 0.008% after being immersed in water for 24 hours in accordance with ISO 62-1:2008. The high naphthenic polymers may also have a moisture adsorption of about 0.01% or less, in some embodiments about 0.008% or less, and in some embodiments, from about 0.0001% to about 0.006% after being exposed to a humid atmosphere (50% relative humidity) at a temperature of 23° C. in accordance with ISO 62-4:2008.

B. Laser Activatable Additive

The polymer composition is “laser activatable” in the sense that it contains an additive that can be activated by a laser direct structuring (“LDS”) process. In such a process, the additive is exposed to a laser that causes the release of metals. The laser thus draws the pattern of conductive elements onto the part and leaves behind a roughened surface containing embedded metal particles. These particles act as nuclei for the crystal growth during a subsequent plating process (e.g., copper plating, gold plating, nickel plating, silver plating, zinc plating, tin plating, etc.). Laser activatable additives typically constitute from about 1 to about 30 parts by weight, in some embodiments from about 2 to about 25 parts by weight, in some embodiments from about 6 to about 20 parts, and in some embodiments, from about 8 to about 13 parts by weight per 100 parts by weight of the polymer matrix. For example, laser activatable additives may constitute from about 0.5 wt. % to about 20 wt. %, in some embodiments from about 1 wt. % to about 15 wt. %, in some embodiments from about 2 wt. % to about 10 wt. %, and in some embodiments, from about 4 wt. % to about 7 wt. % of the polymer composition. The laser activatable additive may include spinel crystals, which may include two or more metal oxide cluster configurations within a definable crystal formation. For example, the overall crystal formation may have the following general formula:

AB₂O₄
wherein,
A is a metal cation having a valance of 2, such as cadmium, chromium, manganese, nickel, zinc, copper, cobalt, iron, magnesium, tin, titanium, etc., as well as combinations thereof; and
B is a metal cation having a valance of 3, such as chromium, iron, aluminum, nickel, manganese, tin, etc., as well as combinations thereof.

Typically, A in the formula above provides the primary cation component of a first metal oxide cluster and B provides the primary cation component of a second metal oxide cluster. These oxide clusters may have the same or different structures. In one embodiment, for example, the first metal oxide cluster has a tetrahedral structure and the second metal oxide cluster has an octahedral cluster. Regardless, the clusters may together provide a singular identifiable crystal type structure having heightened susceptibility to electromagnetic radiation. Examples of suitable spinel crystals include, for instance, MgAl₂O₄, ZnAl₂O₄, FeAl₂O₄, CuFe₂O₄, CuCr₂O₄, MnFe₂O₄, NiFe₂O₄, TiFe₂O₄, FeCr₂O₄, MgCr₂O₄, etc. Copper chromium oxide (CuCr₂O₄) is particularly suitable for use in the present invention and is available from Shepherd Color Co. under the designations 1 G or LD 14 (Shepherd Color Co.).

C. Inorganic Fibers

Inorganic fibers are also employed in the polymer composition to improve the thermal and mechanical properties of the composition without having a significant impact on the dielectric properties of the composition. The inorganic fibers typically have a high degree of tensile strength relative to their mass. For example, the ultimate tensile strength of the fibers (determined in accordance with ASTM D822/D822M-13 (2018)) is typically from about 1,000 to about 15,000 Megapascals (“MPa”), in some embodiments from about 2,000 MPa to about 10,000 MPa, and in some embodiments, from about 3,000 MPa to about 6,000 MPa. To help maintain the desired dielectric properties, the inorganic fibers may be formed from materials that are generally insulative in nature, such as glass, ceramics (e.g., alumina or silica), etc. Glass fibers are particularly suitable, such as E-glass, A-glass, C-glass, D-glass, AR-glass, R-glass, S1-glass, S2-glass, etc.

Further, although the fibers may have a variety of different sizes, fibers having a certain size can help improve the mechanical properties of the resulting polymer composition. The inorganic fibers may, for example, have a nominal diameter of about 5 micrometers or more, in some embodiments about 6 micrometers or more, in some embodiments from about 8 micrometers to about 40 micrometers, and in some embodiments from about 9 micrometers to about 20 micrometers. The fibers (after compounding) may also have a relatively high aspect ratio (average length divided by nominal diameter), such as about 2 or more, in some embodiments about 4 or more, in some embodiments from about 5 to about 50, and in some embodiments, from about 8 to about 40 are particularly beneficial. Such fibers may, for instance, have a volume average length (after compounding) of about 10 micrometers or more, in some embodiments about 25 micrometers or more, in some embodiments from about 50 micrometers or more to about 800 micrometers or less, and in some embodiments from about 60 micrometers to about 500 micrometers. The relative amount of the fibers may also be selectively controlled to help achieve the desired mechanical and thermal properties without adversely impacting other properties of the composition, such as its flowability and dielectric properties, etc. For example, the fibers may be employed in a sufficient amount so that the weight ratio of the inorganic fibers to the laser activatable additive is from about 3 to about 10, in some embodiments from about 3.5 about 8, and in some embodiments from about 4 to about 7. The inorganic fibers may, for instance, constitute from about 40 to about 100 parts by weight, in some embodiments from about 50 to about 80 parts by weight, and in some embodiments, from about 55 to about 70 parts by weight per 100 parts by weight of the polymer matrix. For example, the inorganic fibers may constitute from about 20 wt. % to about 60 wt. %, in some embodiments from about 25 wt. % to about 50 wt. %, and in some embodiments, from about 30 wt. % to about 40 wt. % of the polymer composition.

D. Other Components

In addition to the components noted above, the polymer composition may also contain a variety of other optional components to help improve its overall properties. For example, an inorganic particulate filler may be employed for improving certain properties of the polymer composition. The inorganic particulate filler may be employed in the polymer composition in an amount of from about 1 to about 25 parts, in some embodiments from about 4 to about 22 parts, and in some embodiments, from about 5 to about 20 parts by weight per 100 parts of the liquid crystalline polymer(s) employed in the polymer composition. For instance, the particulate filler may constitute from about 1 wt. % to about 30 wt. %, in some embodiments from about 2 wt. % to about 20 wt. %, and in some embodiments, from about 5 wt. % to about 10 wt. % of the polymer composition.

In certain embodiments, the particles may be formed from a natural and/or synthetic mineral, such as talc, mica, halloysite, kaolinite, illite, montmorillonite, vermiculite, palygorskite, pyrophyllite, calcium silicate, aluminum silicate, wollastonite, etc. Talc is particularly suitable for use in the polymer composition. Other suitable inorganic filler particles may include, for instance, silica, alumina, calcium carbonate, etc. The shape of the particles may vary as desired, such as granular, flake-shaped, etc. The particles typically have a median particle diameter (D50) of from about 1 to about 25 micrometers, in some embodiments from about 2 to about 15 micrometers, and in some embodiments, from about 4 to about 10 micrometers, as determined by sedimentation analysis (e.g., Sedigraph 5120). If desired, the particles may also have a high specific surface area, such as from about 1 square meters per gram (m²/g) to about 50 m²/g, in some embodiments from about 1.5 m²/g to about 25 m²/g, and in some embodiments, from about 2 m²/g to about 15 m²/g. Surface area may be determined by the physical gas adsorption (BET) method (nitrogen as the adsorption gas) in accordance with DIN 66131:1993. The moisture content may also be relatively low, such as about 5% or less, in some embodiments about 3% or less, and in some embodiments, from about 0.1 to about 1% as determined in accordance with ISO 787-2:1981 at a temperature of 105° C.

An organosilane compound may also be employed in the polymer composition, such as in an amount of from about 0.01 to about 5 parts, in some embodiments from about 0.05 to about 3 parts, and in some embodiments, from about 0.1 to about 1 part by weight per 100 parts by weight of the polymer matrix. For example, organosilane compounds can constitute from about 0.01 wt. % to about 3 wt. %, in some embodiments from about 0.02 wt. % to about 2 wt. %, and in some embodiments, from about 0.05 to about 1 wt. % of the polymer composition. The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

R⁵—Si—(R⁶)₃,
wherein,
R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth;
R⁶ is an alkoxy group of from 1 to 10 carbon atoms, such as methoxy, ethoxy, propoxy, and so forth.

Some representative examples of organosilane compounds that may be included in the mixture include mercaptopropyl trimethyoxysilane, mercaptopropyl triethoxysilane, aminopropyl triethoxysilane, aminoethyl triethoxysilane, aminopropyl trimethoxysilane, aminoethyl trimethoxysilane, ethylene trimethoxysilane, ethylene triethoxysilane, ethyne trimethoxysilane, ethyne triethoxysilane, aminoethylaminopropyltrimethoxysilane, 3-aminopropyl triethoxysilane, 3-aminopropyl trimethoxysilane, 3-aminopropyl methyl dimethoxysilane or 3-aminopropyl methyl diethoxysilane, N-(2-aminoethyl)-3-aminopropyl trimethoxysilane, N-methyl-3-aminopropyl trimethoxysilane, N-phenyl-3-aminopropyl trimethoxysilane, bis(3-aminopropyl) tetramethoxysilane, bis(3-aminopropyl) tetraethoxy disiloxane, γ-aminopropyltrimethoxysilane, γ-aminopropyltriethoxysilane, γ-aminopropylmethyldimethoxysilane, γ-aminopropylmethyldiethoxysilane, N-(β-aminoethyl)-γ-aminopropyltrimethoxysilane, N-phenyl-γ-aminopropyltrimethoxysilane, γ-diallylaminopropyltrimethoxysilane, γ-diallylaminopropyltrimethoxysilane, etc., as well as combinations thereof. Particularly suitable organosilane compounds are 3-aminopropyltriethoxysilane and 3-mercaptopropyltrimethoxysilane.

A wide variety of additional additives can also be included in the polymer composition, such as lubricants, thermally conductive fillers, pigments, antioxidants, stabilizers, surfactants, waxes, flame retardants, anti-drip additives, nucleating agents (e.g., boron nitride), flow modifiers (e.g., aluminum trihydroxide), and other materials added to enhance properties and processability. When employed, for example, lubricants and/or flow modifiers such may constitute from about 0.05 wt. % to about 5 wt. %, and in some embodiments, from about 0.1 wt. % to about 1 wt. % of the polymer composition.

### II. Formation

The components used to form the polymer composition may be combined together using any of a variety of different techniques as is known in the art. In one particular embodiment, for example, the polyarylene sulfide(s), condensation polymer(s), laser activatable additive, inorganic fibers, and other optional additives are melt processed as a mixture within an extruder to form the polymer composition. The mixture may be melt-kneaded in a single-screw or multi-screw extruder at a temperature of from about 250° C. to about 450° C. In one embodiment, the mixture may be melt processed in an extruder that includes multiple temperature zones. The temperature of individual zones is typically set within about −60° C. to about 25° C. relative to the melting temperature of the highest melting polymer (e.g., condensation polymer). By way of example, the mixture may be melt processed using a twin screw extruder such as a Leistritz 18-mm co-rotating fully intermeshing twin screw extruder. A general purpose screw design can be used to melt process the mixture. In one embodiment, the mixture including all of the components may be fed to the feed throat in the first barrel by means of a volumetric feeder. In another embodiment, different components may be added at different addition points in the extruder, as is known. For example, the polyarylene sulfide(s) and/or condensation polymer(s) may be applied at the feed throat, and certain additives (e.g., laser activatable additive, inorganic fibers, etc.) may be supplied at the same or different temperature zone located downstream therefrom. Regardless, the resulting mixture can be melted and mixed then extruded through a die. The extruded polymer composition can then be quenched in a water bath to solidify and granulated in a pelletizer followed by drying.

The melt viscosity of the resulting composition may generally be low enough that it can readily flow into the cavity of a mold to form a small-sized circuit substrate. For example, in one particular embodiment, the polymer composition may have a melt viscosity of about 600 Pa-s or less, in some embodiments about 500 Pa-s or less, in some embodiments from about 50 Pa-s to about 475 Pa-s, and in some embodiments, from about 100 to about 450 Pa-s, as determined in accordance with ISO 11443:2021 at a temperature of about 310° C. and at a shear rate of 400 s⁻¹.

### III. Substrate

Once formed, the polymer composition may be molded into the desired shape of a substrate for use in an antenna system. Due to the beneficial properties of the polymer composition, the resulting substrate may have a very small size, such as a thickness of about 5 millimeters or less, in some embodiments about 4 millimeters or less, and in some embodiments, from about 0.1 to about 3 millimeters. Typically, the shaped parts are molded using a one-component injection molding process in which dried and preheated plastic granules are injected into the mold. The conductive elements may be formed in a variety of ways, such as by plating, electroplating, laser direct structuring, etc. When containing spinel crystals as a laser activatable additive, for instance, activation with a laser may cause a physio-chemical reaction in which the spinel crystals are cracked open to release metal atoms. These metal atoms can act as a nuclei for metallization (e.g., reductive copper coating). The laser also creates a microscopically irregular surface and ablates the polymer matrix, creating numerous microscopic pits and undercuts in which the copper can be anchored during metallization.

If desired, the conductive elements may be antenna elements (e.g., antenna resonating elements) so that the resulting part forms an antenna system. The conductive elements can form antennas of a variety of different types, such as antennae with resonating elements that are formed from patch antenna elements, inverted-F antenna elements, closed and open slot antenna elements, loop antenna elements, monopoles, dipoles, planar inverted-F antenna elements, hybrids of these designs, etc. The resulting antenna system can be employed in a variety of different electronic components. As an example, the antenna system may be formed in electronic components, such as desktop computers, portable computers, handheld electronic devices, automotive equipment, etc. In one suitable configuration, the antenna system is formed in the housing of a relatively compact portable electronic component in which the available interior space is relatively small. Examples of suitable portable electronic components include cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, etc. The antenna could also be integrated with other components such as camera module, speaker or battery cover of a handheld device.

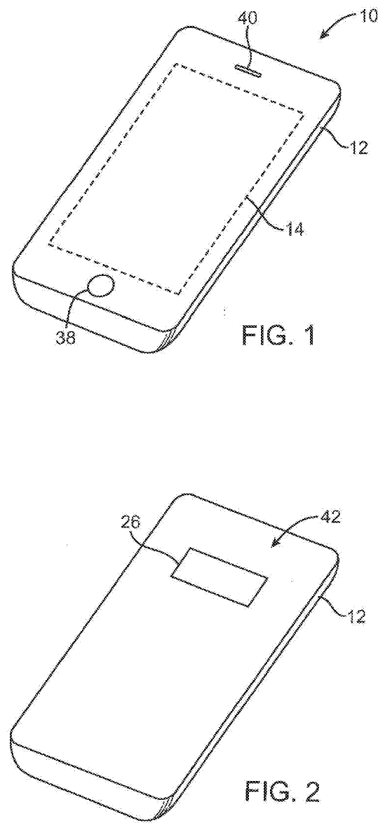

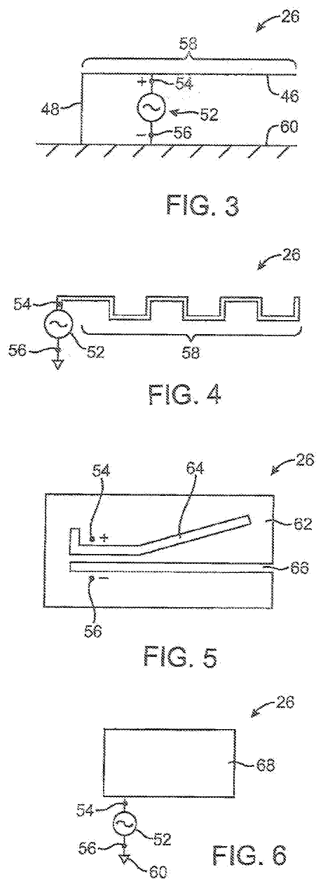

One particularly suitable electronic component is shown in FIGS. 1-2 is a handheld device 10 with cellular telephone capabilities. As shown in FIG. 1, the device 10 may have a housing 12 formed from plastic, metal, other suitable dielectric materials, other suitable conductive materials, or combinations of such materials. A display 14 may be provided on a front surface of the device 10, such as a touch screen display. The device 10 may also have a speaker port 40 and other input-output ports. One or more buttons 38 and other user input devices may be used to gather user input. As shown in FIG. 2, an antenna system 26 is also provided on a rear surface 42 of device 10, although it should be understood that the antenna system can generally be positioned at any desired location of the device. The antenna system may be electrically connected to other components within the electronic device using any of a variety of known techniques. Referring again to FIGS. 1-2, for example, the housing 12 or a part of housing 12 may serve as a conductive ground plane for the antenna system 26. This is more particularly illustrated in FIG. 3, which shows the antenna system 26 as being fed by a radio-frequency source 52 at a positive antenna feed terminal 54 and a ground antenna feed terminal 56. The positive antenna feed terminal 54 may be coupled to an antenna resonating element 58, and the ground antenna feed terminal 56 may be coupled to a ground element 60. The resonating element 58 may have a main arm 46 and a shorting branch 48 that connects main arm 46 to ground 60.

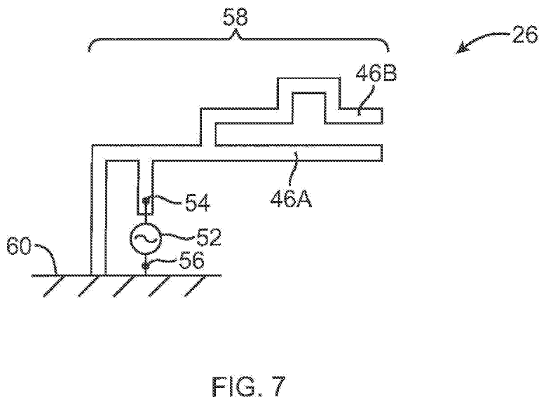

Various other configurations for electrically connecting the antenna system are also contemplated. In FIG. 4, for instance, the antenna system is based on a monopole antenna configuration and the resonating element 58 has a meandering serpentine path shape. In such embodiments, the feed terminal 54 may be connected to one end of resonating element 58, and the ground feed terminal 56 may be coupled to housing 12 or another suitable ground plane element. In another embodiment as shown in FIG. 5, conductive antenna elements 62 are configured to define a closed slot 64 and an open slot 66. The antenna formed from structures 62 may be fed using positive antenna feed terminal 54 and ground antenna feed terminal 56. In this type of arrangement, slots 64 and 66 serve as antenna resonating elements for the antenna element 26. The sizes of the slots 64 and 66 may be configured so that the antenna element 26 operates in desired communications bands (e.g., 2.4 GHz and 5 GHz, etc.). Another possible configuration for the antenna system 26 is shown in FIG. 6. In this embodiment, the antenna element 26 has a patch antenna resonating element 68 and may be fed using positive antenna feed terminal 54 and ground antenna feed terminal 56. The ground 60 may be associated with housing 12 or other suitable ground plane elements in device 10. FIG. 7 shows yet another illustrative configuration that may be used for the antenna elements of the antenna system 26. As shown, antenna resonating element 58 has two main arms 46A and 46B. The arm 46A is shorter than the arm 46B and is therefore associated with higher frequencies of operation than the arm 46A. By using two or more separate resonating element structures of different sizes, the antenna resonating element 58 can be configured to cover a wider bandwidth or more than a single communications band of interest.

In certain embodiments of the present invention, the polymer composition may be particularly well suited for high frequency antennas and antenna arrays for use in base stations, repeaters (e.g., “femtocells”), relay stations, terminals, user devices, and/or other suitable components of 5G systems. As used herein, “5G” generally refers to high speed data communication over radio frequency signals. 5G networks and systems are capable of communicating data at much faster rates than previous generations of data communication standards (e.g., “4G, “LTE”). For example, as used herein, “5G frequencies” can refer to frequencies that are 1.5 GHz or more, in some embodiments about 2.0 GHz or more, in some embodiments about 2.5 GHz or higher, in some embodiments about 3.0 GHz or higher, in some embodiments from about 3 GHz to about 300 GHz, or higher, in some embodiments from about 4 GHz to about 80 GHz, in some embodiments from about 5 GHz to about 80 GHz, in some embodiments from about 20 GHz to about 80 GHz, and in some embodiments from about 28 GHz to about 60 GHz. Various standards and specifications have been released quantifying the requirements of 5G communications. As one example, the International Telecommunications Union (ITU) released the International Mobile Telecommunications—2020 (“IMT-2020”) standard in 2015. The IMT-2020 standard specifies various data transmission criteria (e.g., downlink and uplink data rate, latency, etc.) for 5G. The IMT-2020 Standard defines uplink and downlink peak data rates as the minimum data rates for uploading and downloading data that a 5G system must support. The IMT-2020 standard sets the downlink peak data rate requirement as 20 Gbit/s and the uplink peak data rate as 10 Gbit/s. As another example, 3^{rd} Generation Partnership Project (3GPP) recently released new standards for 5G, referred to as “5G NR.” 3GPP published “Release 15” in 2018 defining “Phase 1” for standardization of 5G NR. 3GPP defines 5G frequency bands generally as “Frequency Range 1” (FR1) including sub-6 GHz frequencies and “Frequency Range 2” (FR2) as frequency bands ranging from 20-60 GHz. Antenna systems described herein can satisfy or qualify as “5G” under standards released by 3GPP, such as Release 15 (2018), and/or the IMT-2020 Standard.

To achieve high speed data communication at high frequencies, antenna elements and arrays may employ small feature sizes/spacing (e.g., fine pitch technology) that can improve antenna performance. For example, the feature size (spacing between antenna elements, width of antenna elements) etc. is generally dependent on the wavelength (“λ”) of the desired transmission and/or reception radio frequency propagating through the substrate dielectric on which the antenna element is formed (e.g., nλ/4 where n is an integer). Further, beamforming and/or beam steering can be employed to facilitate receiving and transmitting across multiple frequency ranges or channels (e.g., multiple-in-multiple-out (MIMO), massive MIMO).

The high frequency 5G antenna elements can have a variety of configurations. For example, the 5G antenna elements can be or include co-planar waveguide elements, patch arrays (e.g., mesh-grid patch arrays), other suitable 5G antenna configurations. The antenna elements can be configured to provide MIMO, massive MIMO functionality, beam steering, and the like. As used herein “massive” MIMO functionality generally refers to providing a large number transmission and receiving channels with an antenna array, for example 8 transmission (Tx) and 8 receive (Rx) channels (abbreviated as 8×8). Massive MIMO functionality may be provided with 8×8, 12×12, 16×16, 32×32, 64×64, or greater.

The antenna elements can have a variety of configurations and arrangements and can be fabricated using a variety of manufacturing techniques. As one example, the antenna elements and/or associated elements (e.g., ground elements, feed lines, etc.) can employ fine pitch technology. Fine pitch technology generally refers to small or fine spacing between their components or leads. For example, feature dimensions and/or spacing between antenna elements (or between an antenna element and a ground plane) can be about 1,500 micrometers or less, in some embodiments 1,250 micrometers or less, in some embodiments 750 micrometers or less (e.g., center-to-center spacing of 1.5 mm or less), 650 micrometers or less, in some embodiments 550 micrometers or less, in some embodiments 450 micrometers or less, in some embodiments 350 micrometers or less, in some embodiments 250 micrometers or less, in some embodiments 150 micrometers or less, in some embodiments 100 micrometers or less, and in some embodiments 50 micrometers or less. However, it should be understood that feature sizes and/or spacings that are smaller and/or larger may be employed within the scope of this disclosure.

As a result of such small feature dimensions, antenna systems can be achieved with a large number of antenna elements in a small footprint. For example, an antenna array can have an average antenna element concentration of greater than 1,000 antenna elements per square centimeter, in some embodiments greater than 2,000 antenna elements per square centimeter, in some embodiments greater than 3,000 antenna elements per square centimeter, in some embodiments greater than 4,000 antenna elements per square centimeter, in some embodiments greater than 6,000 antenna elements per square centimeter, and in some embodiments greater than about 8,000 antenna elements per square centimeter. Such compact arrangement of antenna elements can provide a greater number of channels for MIMO functionality per unit area of the antenna area. For example, the number of channels can correspond with (e.g., be equal to or proportional with) the number of antenna elements.

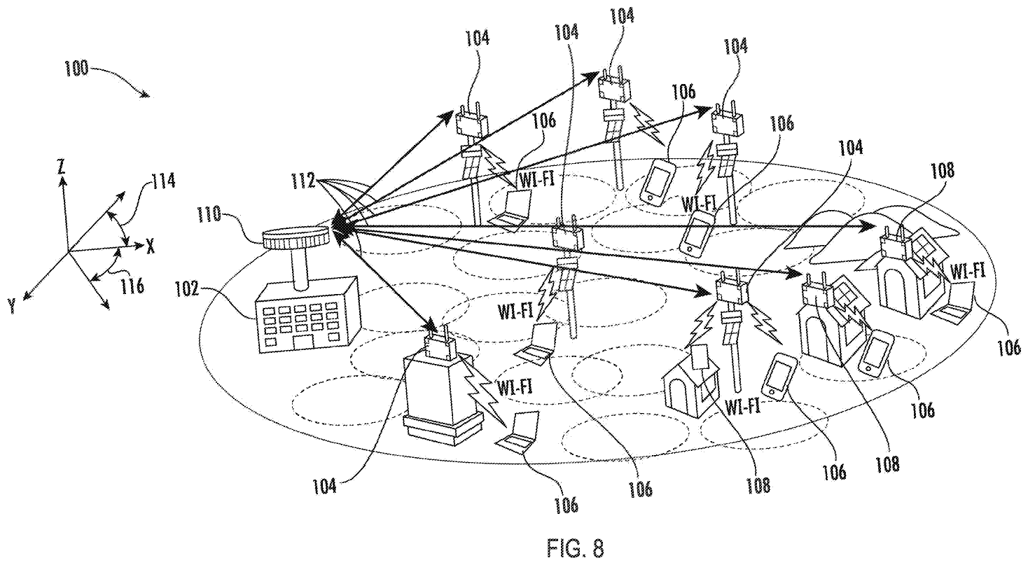

Referring to FIG. 8, one embodiment of a 5G antenna system 100 is shown that also includes a base station 102, one or more relay stations 104, one or more user computing devices 106, one or more Wi-Fi repeaters 108 (e.g., “femtocells”), and/or other suitable antenna components for the 5G antenna system 100. The relay stations 104 can be configured to facilitate communication with the base station 102 by the user computing devices 106 and/or other relay stations 104 by relaying or “repeating” signals between the base station 102 and the user computing devices 106 and/or relay stations 104. The base station 102 can include a MIMO antenna array 110 configured to receive and/or transmit radio frequency signals 112 with the relay station(s) 104, Wi-Fi repeaters 108, and/or directly with the user computing device(s) 106. The user computing device 306 is not necessarily limited by the present invention and include devices such as 5G smartphones.

The MIMO antenna array 110 can employ beam steering to focus or direct radio frequency signals 112 with respect to the relay stations 104. For example, the MIMO antenna array 110 can be configured to adjust an elevation angle 114 with respect to an X-Y plane and/or a heading angle 116 defined in the Z-Y plane and with respect to the Z direction. Similarly, one or more of the relay stations 104, user computing devices 106, Wi-Fi repeaters 108 can employ beam steering to improve reception and/or transmission ability with respect to MIMO antenna array 110 by directionally tuning sensitivity and/or power transmission of the device 104, 106, 108 with respect to the MIMO antenna array 110 of the base station 102 (e.g., by adjusting one or both of a relative elevation angle and/or relative azimuth angle of the respective devices).

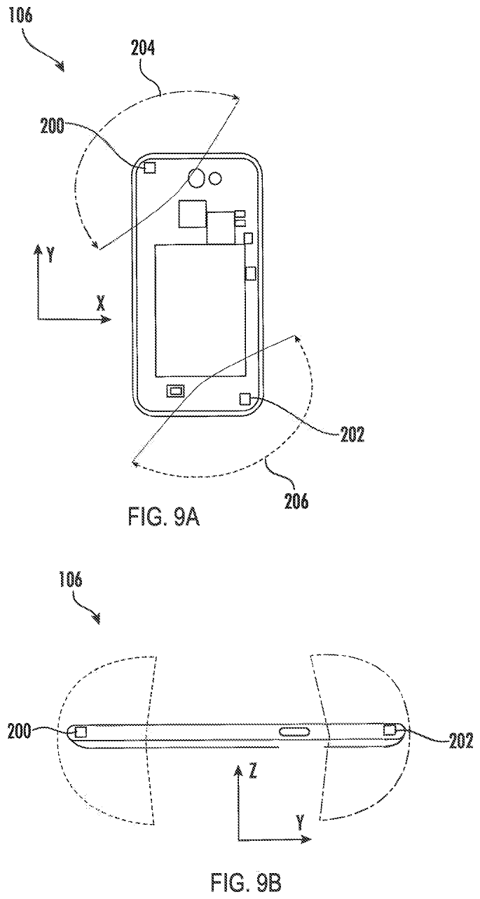

FIGS. 9A and 9B illustrate a top-down and side elevation view, respectively, of an example user computing device 106. The user computing device 106 may include one or more antenna elements 200, 202 (e.g., arranged as respective antenna arrays). Referring to FIG. 9A, the antenna elements 200, 202 can be configured to perform beam steering in the X-Y plane (as illustrated by arrows 204, 206 and corresponding with a relative azimuth angle). Referring to FIG. 9B, the antenna elements 200, 202 can be configured to perform beam steering in the Z-Y plane (as illustrated by arrows 204, 206).

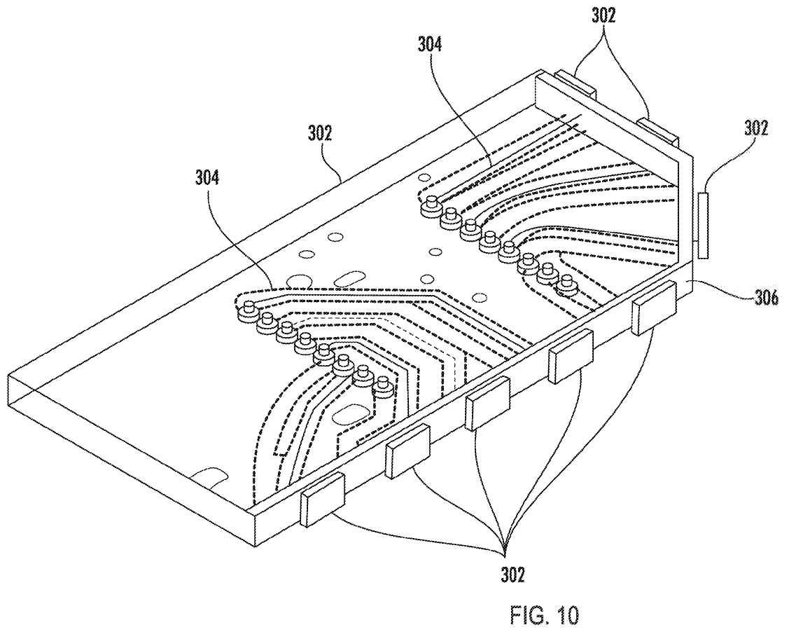

FIG. 10 depicts a simplified schematic view of a plurality of antenna arrays 302 connected using respective feed lines 304 (e.g., with a front end module). The antenna arrays 302 can be mounted to a side surface 306 of a substrate 308, which may be formed from the polymer composition of the present invention. The antenna arrays 302 can include a plurality of vertically connected elements (e.g., as a mesh-grid array). Thus, the antenna array 302 can generally extend parallel with the side surface 306 of the substrate 308. Shielding can optionally be provided on the side surface 306 of the substrate 308 such that the antenna arrays 302 are located outside of the shielding with respect to the substrate 308. The vertical spacing distance between the vertically connected elements of the antenna array 302 can correspond with the “feature sizes” of the antenna arrays 320. As such, in some embodiments, these spacing distances may be relatively small (e.g., less than about 750 micrometers) such that the antenna array 302 is a “fine pitch” antenna array 302.

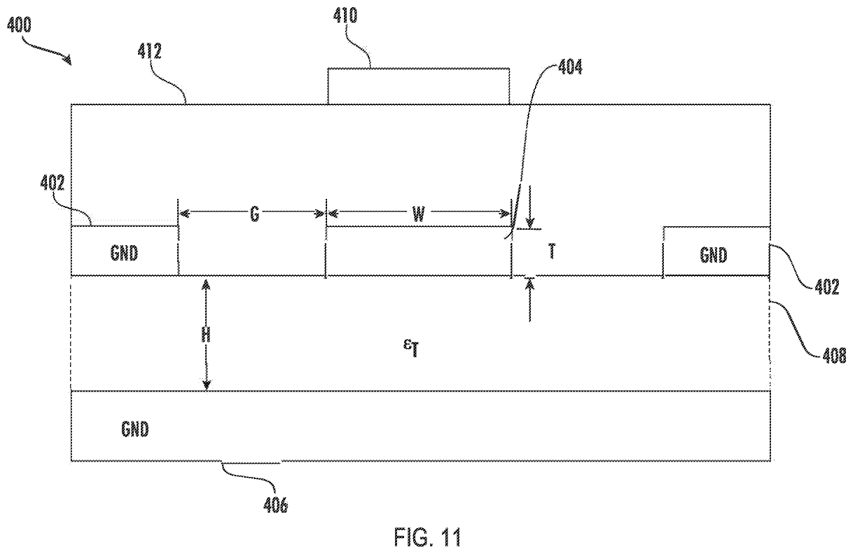

FIG. 11 illustrates a side elevation view of a co-planar waveguide antenna 400 configuration. One or more co-planar ground layers 402 can be arranged parallel with an antenna element 404 (e.g., a patch antenna element). Another ground layer 406 may be spaced apart from the antenna element by a substrate 408, which may be formed from the polymer composition of the present invention. One or more additional antenna elements 410 can be spaced apart from the antenna element 404 by a second layer or substrate 412, which may also be formed from the polymer composition of the present invention. The dimensions “G” and “W” may correspond with “feature sizes” of the antenna 400. The “G” dimension may correspond with a distance between the antenna element 404 and the co-planar ground layer(s) 406. The “W” dimension can correspond with a width (e.g., linewidth) of the antenna element 404. As such, in some embodiments, dimensions “G” and “W” may be relatively small (e.g., less than about 750 micrometers) such that the antenna 400 is a “fine pitch” antenna 400.

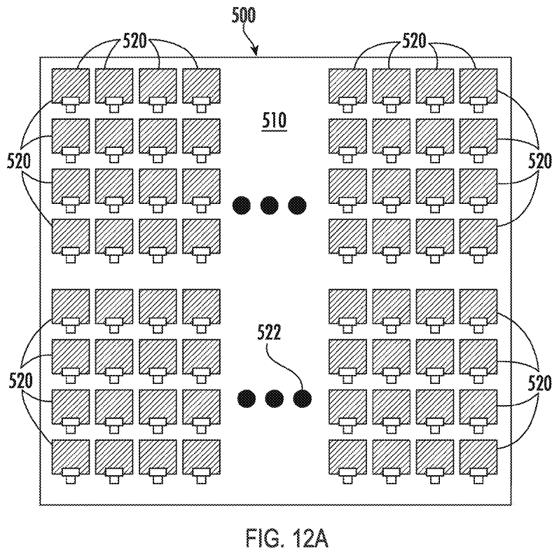

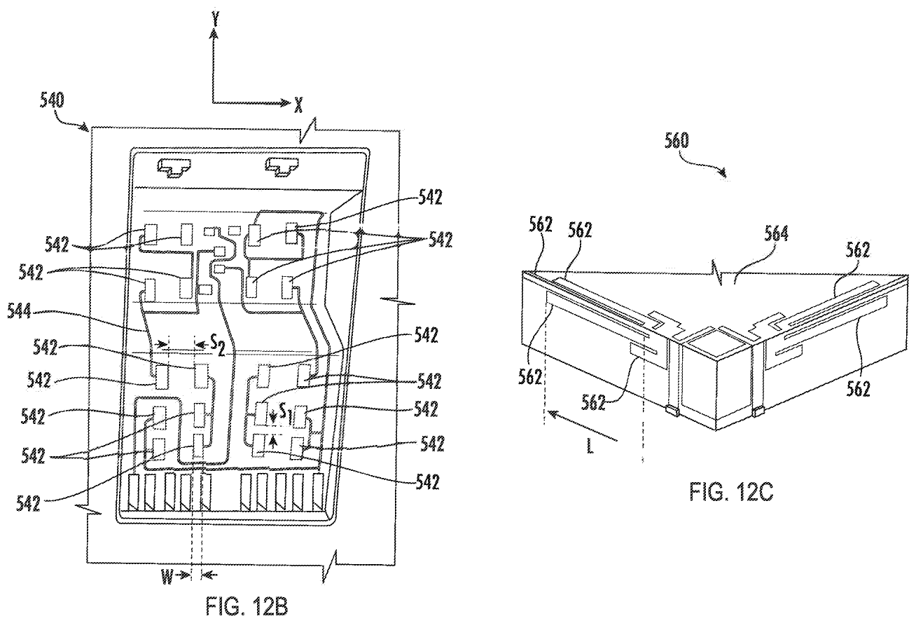

FIG. 12A illustrates an antenna array 500 according to another aspect of the present disclosure. The antenna array 500 can include a substrate 510, which may be formed from the polymer composition of the present invention, and a plurality of antenna elements 520 formed thereon. The plurality of antenna elements 520 can be approximately equally sized in the X- and/or Y-directions (e.g., square or rectangular). The plurality of antenna elements 520 can be spaced apart approximately equally in the X- and/or Y-directions. The dimensions of the antenna elements 520 and/or spacing therebetween can correspond with “feature sizes” of the antenna array 500. As such, in some embodiments, the dimensions and/or spacing may be relatively small (e.g., less than about 750 micrometers) such that the antenna array 500 is a “fine pitch” antenna array 500. As illustrated by the ellipses 522, the number of columns of antenna elements 520 illustrated in FIG. 12 is provided as an example only. Similarly, the number of rows of antenna element 520 is provided as an example only.

The tuned antenna array 500 can be used to provide massive MIMO functionality, for example in a base station (e.g., as described above with respect to FIG. 8). More specifically, radio frequency interactions between the various elements can be controlled or tuned to provide multiple transmitting and/or receiving channels. Transmitting power and/or receiving sensitivity can be directionally controlled to focus or direct radio frequency signals, for example as described with respect to the radio frequency signals 112 of FIG. 8. The tuned antenna array 500 can provide a large number of antenna elements 522 in a small footprint. For example, the tuned antenna 500 can have an average antenna element concentration of 1,000 antenna elements per square cm or greater. Such compact arrangement of antenna elements can provide a greater number of channels for MIMO functionality per unit area. For example, the number of channels can correspond with (e.g., be equal to or proportional with) the number of antenna elements.

FIG. 12B illustrates an antenna array 540 formed with laser direct structuring, which may optionally be employed to form the antenna elements. The antenna array 540 can include a plurality of antenna elements 542 and plurality of feed lines 544 connecting the antenna elements 542 (e.g., with other antenna elements 542, a front end module, or other suitable component). The antenna elements 542 can have respective widths “w” and spacing distances “S₁” and “S₂” therebetween (e.g., in the X-direction and Y-direction, respectively). These dimensions can be selected to achieve 5G radio frequency communication at a desired 5G frequency. More specifically, the dimensions can be selected to tune the antenna array 540 for transmission and/or reception of data using radio frequency signals that are within the 5G frequency spectrum. The dimensions can be selected based on the material properties of the substrate. For example, one or more of “w”, “S₁,” or “S₂” can correspond with a multiple of a propagation wavelength (“λ”) of the desired frequency through the substrate material (e.g., nλ/4 where n is an integer).

As one example, λ can be calculated as follows:

$$λ = \frac{c}{f \sqrt{{ϵ}_{R}}}$$

where c is the speed of light in a vacuum, ϵ_{R} is the dielectric constant of the substrate (or surrounding material), f is the desired frequency.

FIG. 12C illustrates an example antenna configuration 560 according to aspects of the present disclosure. The antenna configuration 560 can include multiple antenna elements 562 arranged in parallel long edges of a substrate 564, which may be formed from the polymer composition of the present invention. The various antenna elements 562 can have respective lengths, “L” (and spacing distances therebetween) that tune the antenna configuration 560 for reception and/or transmission at a desired frequency and/or frequency range. More specifically, such dimensions can be selected based on a propagation wavelength, A, at the desired frequency for the substrate material, for example as described above with reference to FIG. 12B.

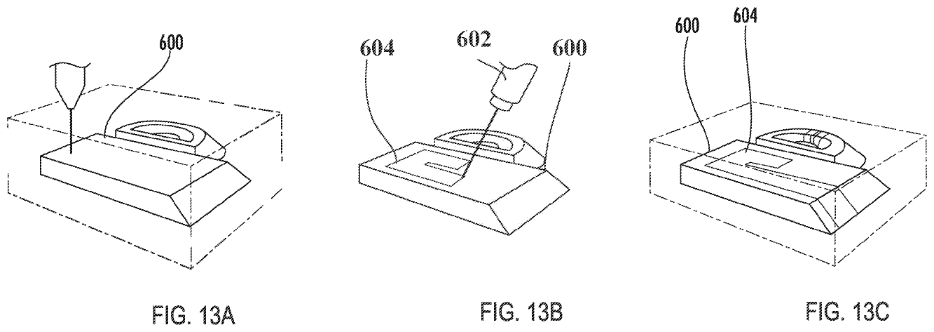

FIGS. 13A through 13C depict simplified sequential diagrams of a laser direct structuring manufacturing process that can be used to form antenna elements and/or arrays according to aspects of the present disclosure. Referring to FIG. 13A, a substrate 600 can be formed from the polymer composition of the present invention using any desired technique (e.g., injection molding). In certain embodiments, as shown in FIG. 13B, a laser 602 can be used to activate the laser activatable additive to form a circuit pattern 604 that can include one or more of the antenna elements and/or arrays. For example, the laser can melt conductive particles in the polymer composition to form the circuit pattern 604. Referring to FIG. 13C, the substrate 600 can be submerged in an electroless copper bath to plate the circuit pattern 604 and form the antenna elements, elements arrays, other components, and/or conductive lines therebetween.

The present invention may be better understood with reference to the following examples.

### Test Methods

Melt Viscosity: The melt viscosity (Pa-s) may be determined in accordance with ISO 11443:2021 at a shear rate of 400 s⁻¹ and temperature 15° C. above the melting temperature (e.g., about 350° C.) using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod was 233.4 mm. The melt viscosity is typically determined at a temperature of 310° C.

Melting Temperature: The melting temperature (“Tm”) may be determined by differential scanning calorimetry (“DSC”) as is known in the art. The melting temperature is the differential scanning calorimetry (DSC) peak melt temperature as determined by ISO 11357-3:2018. Under the DSC procedure, samples were heated and cooled at 20° C. per minute as stated in ISO Standard 10350 using DSC measurements conducted on a TA Q2000 Instrument.

Deflection Temperature Under Load (“DTUL”): The deflection under load temperature may be determined in accordance with ISO 75-2:2013 (technically equivalent to ASTM D648). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Tensile Modulus, Tensile Stress, and Tensile Elongation: Tensile properties may be tested according to ISO 527:2019 (technically equivalent to ASTM D638). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus, Flexural Stress, and Flexural Elongation: Flexural properties may be tested according to ISO 178:2019 (technically equivalent to ASTM D790). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010 (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

Dielectric Constant (“Dk”) and Dissipation Factor (“Df”): The dielectric constant (or relative static permittivity) and dissipation factor are determined using a known split-post dielectric resonator technique, such as described in Baker-Jarvis, et al., IEEE Trans. on Dielectric and Electrical Insulation, 5(4), p. 571 (1998) and Krupka, et al., Proc. 7^{th} International Conference on Dielectric Materials: Measurements and Applications, IEEE Conference Publication No. 430 (September 1996). More particularly, a plaque sample having a size of 80 mm×90 mm×3 mm or a disc sample having a 4-inch and 3-mm thickness may be inserted between two fixed dielectric resonators. The resonator measured the permittivity component in the plane of the specimen. Five (5) samples are tested and the average value is recorded. The split-post resonator can be used to make dielectric measurements in the low gigahertz region, such as 2 GHz or 10 GHz.

### Comparative Example 1

A concentrate is initially formed by compounding 70 wt. % of a liquid crystalline polymer and 30 wt. % of a copper chromite filler (CuCr₂O₄). The liquid crystalline polymer contains 60% HBA, 5% HNA, 17.5% TA, 12.5% BP, and 5% APAP. A polymer composition is thereafter formed from the concentrate such that the final composition contains the LCP/copper chromite concentrate, PPS, glass fibers, talc, 3-aminopropyltriethoxysilane, and a lubricant in the following concentrations:

Comparative Example 1

| | Wt. % | Parts by weight |
|---|---|---|
| PPS | 39.3 | 100 |
| LCP | 17.5 | |
| Copper Chromite | 7.5 | 13.2 |
| Glass Fibers | 20 | 35.2 |
| Talc | 15 | 26.4 |
| Organosilane | 0.4 | 0.7 |
| Lubricant | 0.3 | 0.5 |

The components are melt mixed using a 32 mm Coperion co-rotating, fully-intermeshing, twin-screw extruder. Following formation, the sample may be tested for a variety of physical characteristics. The results are set forth below.

| | Comparative Example 1 |
|---|---|
| Dielectric Constant (2 GHz) | 4.0 |
| Dissipation Factor (2 GHz) | 0.005 |
| Melt Viscosity (Pa-s) at 400 s⁻¹ | 470 |
| Tensile Modulus (MPa) | 12,300 |
| Tensile Break Stress (MPa) | 100 |
| Tensile Break Strain (%) | 1 |
| Flexural Modulus (MPa) | 13,400 |
| Flexural Break Stress (MPa) | 148 |
| Unnotched Charpy Impact Strength (kJ/m²) | 17 |
| Notched Charpy Impact Strength (kJ/m²) | 4.5 |
| DTUL (° C.) at 1.8 MPa | 255 |

### Example 1

A concentrate is initially formed by compounding 70 wt. % of a liquid crystalline polymer and 30 wt. % of a copper chromite filler (CuCr₂O₄). The liquid crystalline polymer contains 60% HBA, 5% HNA, 17.5% TA, 12.5% BP, and 5% APAP. A polymer composition is thereafter formed from the concentrate such that the final composition contains the LOP/copper chromite concentrate, PPS, glass fibers, 3-aminopropyltriethoxysilane, and a lubricant in the following concentrations:

Example 1

| | Wt. % | Parts by weight |
|---|---|---|
| PPS | 45.5 | 100 |
| LCP | 15.4 | |
| Copper Chromite | 6.6 | 10.8 |
| Glass Fibers | 32 | 52.5 |
| Organosilane | 0.2 | 0.3 |
| Lubricant | 0.3 | 0.5 |

The components are melt mixed using a 32 mm Coperion co-rotating, fully-intermeshing, twin-screw extruder. Following formation, the sample may be tested for a variety of physical characteristics. The results are set forth below.

| | Example 1 |
|---|---|
| Dielectric Constant (2 GHz) | 4.0 |
| Dissipation Factor (2 GHz) | 0.005 |
| Melt Viscosity (Pa-s) at 400 s⁻¹ | 380 |
| Tensile Modulus (MPa) | 14,000 |
| Tensile Break Stress (MPa) | 130 |
| Tensile Break Strain (%) | 1.3 |
| Flexural Modulus (MPa) | 14,000 |
| Flexural Break Stress (MPa) | 200 |
| Unnotched Charpy Impact Strength (kJ/m²) | 29 |
| Notched Charpy Impact Strength (kJ/m²) | 6 |
| DTUL (° C.) at 1.8 MPa | 260 |

### Example 2

A polymer composition is formed from the LOP/copper chromite concentrate of Example 1, PPS, glass fibers, 3-aminopropyltriethoxysilane, and a lubricant in the following concentrations:

Example 2

| | Wt. % | Parts by weight |
|---|---|---|
| PPS | 37.5 | 100 |
| LCP | 15.4 | |
| Copper Chromite | 6.6 | 12.5 |
| Glass Fibers | 40 | 75.6 |
| Organosilane | 0.2 | 0.4 |
| Lubricant | 0.3 | 0.6 |

The components are melt mixed using a 32 mm Coperion co-rotating, fully-intermeshing, twin-screw extruder. Following formation, the sample may be tested for a variety of physical characteristics. The results are set forth below.

| | Example 2 |
|---|---|
| Dielectric Constant (2 GHz) | 4.1 |
| Dissipation Factor (2 GHz) | 0.005 |
| Melt Viscosity (Pa-s) at 400 s⁻¹ | 420 |
| Tensile Modulus (MPa) | 17,000 |
| Tensile Break Stress (MPa) | 135 |
| Tensile Break Strain (%) | 1.1 |
| Flexural Modulus (MPa) | 17,500 |
| Flexural Break Stress (MPa) | 220 |
| Unnotched Charpy Impact Strength (kJ/m²) | 24 |
| Notched Charpy Impact Strength (kJ/m²) | 7 |
| DTUL (° C.) at 1.8 MPa | 263 |

### Example 3

A polymer composition is formed from the LOP/copper chromite concentrate of Example 1, PPS, glass fibers, talc, 3-aminopropyltriethoxysilane, and a lubricant in the following concentrations:

Example 3

| | Wt. % | Parts by weight |
|---|---|---|
| PPS | 29.5 | 100 |
| LCP | 15.4 | |
| Copper Chromite | 6.6 | 14.7 |
| Glass Fibers | 40 | 89.1 |
| Talc | 8 | 17.8 |
| Organosilane | 0.2 | 0.4 |
| Lubricant | 0.3 | 0.7 |

The components are melt mixed using a 32 mm Coperion co-rotating, fully-intermeshing, twin-screw extruder. Following formation, the sample may be tested for a variety of physical characteristics. The results are set forth below.

| | Example 3 |
|---|---|
| Dielectric Constant (2 GHz) | 4.4 |
| Dissipation Factor (2 GHz) | 0.006 |
| Melt Viscosity (Pa-s) at 400 s⁻¹ | 450 |
| Tensile Modulus (MPa) | 18,500 |
| Tensile Break Stress (MPa) | 110 |
| Tensile Break Strain (%) | 0.9 |
| Flexural Modulus (MPa) | 19,500 |
| Flexural Break Stress (MPa) | 190 |
| Unnotched Charpy Impact Strength (kJ/m²) | 15 |
| Notched Charpy Impact Strength (kJ/m²) | 7 |
| DTUL (° C.) at 1.8 MPa | 267 |

### Example 4

A polymer composition is formed from the LOP/copper chromite concentrate of Example 1, PPS, glass fibers, talc, 3-aminopropyltriethoxysilane, and a lubricant in the following concentrations:

Example 4

| | Wt. % | Parts by weight |
|---|---|---|
| PPS | 37.5 | 100 |
| LCP | 15.4 | |
| Copper Chromite | 6.6 | 12.5 |
| Glass Fibers | 32 | 60.5 |
| Talc | 8 | 15.1 |
| Organosilane | 0.2 | 0.4 |
| Lubricant | 0.3 | 0.6 |

The components are melt mixed using a 32 mm Coperion co-rotating, fully-intermeshing, twin-screw extruder. Following formation, the sample may be tested for a variety of physical characteristics. The results are set forth below.

| | Example 4 |
|---|---|
| Dielectric Constant (2 GHz) | 4.1 |
| Dissipation Factor (2 GHz) | 0.005 |
| Melt Viscosity (Pa-s) at 400 s⁻¹ | 400 |
| Tensile Modulus (MPa) | 16,000 |
| Tensile Break Stress (MPa) | 120 |
| Tensile Break Strain (%) | 1 |
| Flexural Modulus (MPa) | 17,000 |
| Flexural Break Stress (MPa) | 200 |
| Unnotched Charpy Impact Strength (kJ/m²) | 22 |
| Notched Charpy Impact Strength (kJ/m²) | 8 |
| DTUL (° C.) at 1.8 MPa | 265 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A polymer composition comprising:
100 parts by weight of a polymer matrix that includes at least one polyarylene sulfide in an amount of from about 10 wt. % to about 60 wt. % of the polymer composition and at least one condensation polymer in an amount of from about 5 wt. % to about 35 wt. % of the polymer composition;
from about 1 to about 30 parts by weight of at least one laser activatable additive;
from about 40 to about 100 parts by weight of inorganic fibers; and
wherein the polymer composition exhibits a dielectric constant of about 5 or less at a frequency of 2 GHz, a flexural modulus of about 13,500 MPa or more as determined at a temperature of 23° C. in accordance with ISO 178:2019, and a deflection temperature under load of about 260° C. or more as determined in accordance with ISO 75:2013 at a load of 1.8 MPa.

2. The polymer composition of claim 1, wherein the polyarylene sulfide includes a polyphenylene sulfide.

3. The polymer composition of claim 1, wherein the weight ratio of polyarylene sulfides to condensation polymers within the polymer matrix is from about 1.5 to about 5.

4. The polymer composition of claim 1, wherein the inorganic fibers include glass fibers.

5. The polymer composition of claim 1, wherein the laser activatable additive contains spinel crystals having the following general formula:
AB₂O₄
wherein,
A is a metal cation having a valance of 2; and
B is a metal cation having a valance of 3.

6. The polymer composition of claim 5, wherein the spinel crystals include MgAl₂O₄, ZnAl₂O₄, FeAl₂O₄, CuFe₂O₄, CuCr₂O₄, MnFe₂O₄, NiFe₂O₄, TiFe₂O₄, FeCr₂O₄, MgCr₂O₄, or a combination thereof.

7. The polymer composition of claim 1, further comprising from about 1 to about 25 parts by weight of at least one inorganic particulate filler.

8. The polymer composition of claim 7, wherein the inorganic particulate filler includes talc.

9. The polymer composition of claim 1, wherein the condensation polymer includes an aliphatic, aromatic, and/or aliphatic-aromatic polyester, polyamide, polyacrylamide, polyimide, or a combination thereof.

10. The polymer composition of claim 1, wherein the condensation polymer includes an aromatic polyester.

11. The polymer composition of claim 1, wherein the condensation polymer includes a liquid crystalline polymer.

12. The polymer composition of claim 11, wherein the liquid crystalline polymer contains aromatic ester repeating units, the aromatic ester repeating units including aromatic dicarboxylic acid repeating units and aromatic hydroxycarboxylic acid repeating units.

13. The polymer composition of claim 12, wherein the aromatic hydroxycarboxylic acid repeating units are derived from 4-hydroxybenzoic acid, 6-hydroxy-2-naphthoic acid, or a combination thereof and the aromatic dicarboxylic acid repeating units are derived from terephthalic acid, isophthalic acid, or a combination thereof.

14. The polymer composition of claim 13, wherein the liquid crystalline polymer further contains hydroquinone, 4,4′-biphenol, or a combination thereof.

15. The polymer composition of claim 1, further comprising from about 0.01 to about 5 parts by weight of an organosilane compound.

16. The polymer composition of claim 1, wherein the polymer composition exhibits a dissipation factor of about 0.01 or less at a frequency of 2 GHz.

17. The polymer composition of claim 1, wherein the polymer composition exhibits a tensile strength of about 110 MPa or more as determined at a temperature of 23° C. in accordance with ISO 527:2019.

18. The polymer composition of claim 1, wherein the polymer composition exhibits a tensile modulus of about 13,500 MPa or more as determined at a temperature of 23° C. in accordance with ISO 527:2019.

19. The polymer composition of claim 1, wherein the polymer composition exhibits a flexural strength of about 160 MPa or more as determined at a temperature of 23° C. in accordance with ISO 178:2019.

20. The polymer composition of claim 1, wherein the polymer composition exhibits an unnotched Charpy impact strength of about 15 kJ/m² or more as determined at a temperature of 23° C. in accordance with ISO 179:2020.

21. The polymer composition of claim 1, wherein the polymer composition comprises from about 0.5 wt. % to about 20 wt. % of laser activatable additives and from about 20 wt. % to about 60 wt. % of inorganic fibers.

22. The polymer composition of claim 21, wherein the polymer composition further comprises from about 1 wt. % to about 30 wt. % of inorganic particulate materials.

23. The polymer composition of claim 1, wherein the weight ratio of the inorganic fibers to the laser activatable additive is from about 3 to about 10.

24. The polymer composition of claim 1, wherein the composition exhibits a V-0 rating at a thickness of 1.0 mm as determined in accordance with UL 94.

25. A molded part that comprises the polymer composition of claim 1.

26. The molded part of claim 25, wherein one or more conductive elements are formed on a surface of the part.

27. An antenna system that comprises a substrate that includes the polymer composition of claim 1 and at least one antenna element configured to transmit and receive radio frequency signals, wherein the antenna element is coupled to the substrate.

28. The antenna system of claim 27, wherein the radio frequency signals are 5G signals.

29. The antenna system of claim 27, wherein the at least one antenna element has a feature size that is less than about 1,500 micrometers.

30. The antenna system of claim 27, wherein the at least one antenna element comprises a plurality of antenna elements.

31. The antenna system of claim 30, wherein the plurality of antenna elements are spaced apart by a spacing distance that is less than about 1,500 micrometers.

32. The antenna system of claim 30, wherein the plurality of antenna elements comprise at least 16 antenna elements.

33. The antenna system of claim 30, wherein the plurality of antenna elements are arranged in an array.

34. The antenna system of claim 33, wherein the array is configured for at least 8 transmission channels and at least 8 reception channels.

35. The antenna system of claim 33, wherein the array has an average antenna element concentration of greater than 1,000 antenna elements per square centimeter.

36. The antenna system of claim 27, further comprising a base station, and wherein the base station comprises the at least one antenna element.

37. The antenna system of claim 27, further comprising at least one of a user computing device or a repeater, and wherein the at least one of the user computing device or the repeater base station comprises the at least one antenna element.
